(19) United States
(12) Patent Application Publication
(10) Pub. No.: US 2024/0016589 A1
(43) Pub. Date: Jan. 18, 2024

(54) Dental Flossing Device

(71) Applicant: Calliope Fleming, Seattle, WA (US)

(72) Inventor: Calliope Fleming, Seattle, WA (US)

(21) Appl. No.: 17/866,049

(22) Filed: Jul. 15, 2022

(51) Int. Cl. A61C 15/04

(52) U.S. Cl. CPC A61C 15/046

(57) ABSTRACT

A flossing device having a body configured to bias two strands of dental floss against two different teeth adjoining a gap therebetween is provided. A first leg holding a first floss strand is in a pivoting engagement with a second leg holding a second strand of floss. Upon compression of the first leg against the second leg the two floss strands align in parallel at slightly different elevations wherein the user can easily insert both into a gap between teeth. Release of compression by the user allows the two legs to bias each respective floss strand against a separate tooth on opposing sides of the gap therebetween.

### BACKGROUND OF THE INVENTION

### 1. Field of the Invention

The invention herein disclosed relates generally to dental floss. More particularly, it relates to a hand held dental floss device configured to allow a user to easily place dental floss in position for flossing of two adjacent teeth concurrently.

### 2. Prior Art

Dental floss is conventionally formed by a cord of thin filaments. The cord forming the dental floss is configured in dimension for use in interdental cleaning in a manner adapted to remove food and dental plaque from between teeth, below the gum line, or from places in the mouth of a user where a toothbrush has difficulty reaching. Flossing, using such dental floss in regular use, is considered a vital part of teeth cleaning to maintain oral health.

For example, the use of floss is recommended to prevent gingivitis and the build-up of plaque. The American Dental Association claims that up to 80% of plaque can be removed by flossing, and it may confer a particular benefit in individuals with orthodontic devices.

However, for many individuals, the actual act of flossing can be a significant challenge. For floss users with inhibited hand dexterity, the act of positioning the floss itself against teeth for such flossing action can be hard to accomplish, if at all. Also, for example, for floss users with large hands and fingers, it can be hard to hold the floss in the multiple properly taught positions in the mouth to clean individual teeth.

With respect to the above, before explaining at least one preferred embodiment of the flossing device and system herein, it is to be understood that the invention is not limited in its application to the details of employment and to the arrangement of the components or the steps set forth in the following description or illustrated in the drawings. The various components and construction of the apparatus and methods and steps of employment of the disclosed flossing device are capable of other embodiments and of being practiced and carried out in various ways. All of which will be obvious to those skilled in the art once the information herein is reviewed.

Also, it is to be understood that the phraseology and terminology employed herein are for the purpose of description and should not be regarded as limiting. As such, those skilled in the art will appreciate that the conception upon which this disclosure is based may readily be utilized as a basis for other teeth flossing devices and systems. It is important, therefore, that the embodiments, objects, and claims herein, be regarded as including such equivalent construction and methodology insofar as they do not depart from the spirit and scope of the present invention.

### SUMMARY OF THE INVENTION

The disclosed flossing device and system provide a significant advance in the ease of flossing for users, thereby encouraging regular and ongoing flossing. The device features a floss holder body configured for holding a first taut portion of floss upon a first floss mount on a first member along with a second taut portion of floss upon a second floss mount upon a second member.

The first and second members are in a connection at respective first ends of each member, which may be fixed or stationary or, in some modes, can be a hinge or pivoting engagement. The body is formed of polymeric material which, once molded, will assume a first or default position wherein the first member is separate from the second member by a gap therebetween.

In the first or default position of the first and second member in the connection at the first ends thereof, the first member and second member resist movement toward each other during flexing from force imparted for such by the user. During movement of the two members toward each other by the user, they impart a biasing force of the first member away from the second member which must be overcome by user force. Such an outward biasing force, as noted, may be imparted by forming the body of the device of polymeric material with a memory or elasticity in a single piece in a connection at the first ends of both members. The polymeric material thus forming the body will, by default, be formed to the first position and place the two members to a fixed position with a gap therebetween in substantially a “U” or “V” shape. The polymeric material thereafter will resist movement of the two members toward each other and bias the two members away from each other once the user ceases compression.

While the current preferred mode of the device has a polymeric connection at the first ends of both members, a pivoting engagement or living hinge can also be employed. Where a pivoting engagement is used, a spring engages the first ends of each of the two members. Such an outward biasing force may be imparted by conventional means, such as a spring or the like.

Additionally, the body or at least the two members can be formed of metal and joined at the connection at the first ends. A flexible metal will behave like a polymeric material and will flex when compressed and exert an outward bias.

Also, in another mode of forming the device as a unitary structure with a connection at the first ends of both members holding the floss, a polymeric living hinge or flexure hinge can be used for the connection of the first end of the first member to the first end of the second member. The overall requirement for all modes is that the first member and second member have a first separate position and a bias to return to that first position once force overcoming the bias is released.

By living hinge herein is meant a flexible segment of polymeric material forms the connection of the first member to the second member. Such a living hinge is flexible and elastic, allowing it to bend from a default position to a second position under force from the user and return toward the default position once such pressure is ceased. When bent, by forcing the first member toward the second member engaged thereto, the hinge component connection, along with the bending of the polymeric material of the first and second members, will impart a continuous outward bias to that first member in a direction away from the second member.

As noted however, where the connection is a pivoting engagement, it can be a conventional hinge type engagement of the first member and the second member where the outward biasing force urging the first member away from the second member can be a spring or another flexible member or other biasing means. In all configurations, this outward biasing force resists closure when the first member is moved or flexed to contact the second member during use, and once the user ceases compressive force, both the first member and second member move apart toward the first position.

Currently, the employment of a polymeric connection or a polymeric connection formed as a living hinge simplifies the manufacture of the device and requires no springs or metal or the like and is preferred. However, any configuration of a floss holder, using a first and second member which will flex or move toward and away from each other in a connection at respective first ends, wherein they are separated in a first position and impart a biasing force away from each other when rotated or flexed and placed adjacent each other, is considered within the scope of this invention and the claims herein.

The first member of the floss holder herein has a first mount extending away from the first member to a first mount end, and has a second mount extending substantially parallel to the first mount to a second mount end. A first strand of dental floss is engaged across a first gap between the first and second mounts.

The second member, in the pivoting engagement to the first member, has a third mount extending to a distal end and a fourth mount extending to a distal end thereof. A second strand of dental floss is engaged at opposing ends thereof to the third mount and fourth mount. This second strand extends across a second gap therebetween.

The floss holder is formed and starts in the first or expanded position by default wherein the first member is positioned away from the second member and both members and/or a hinge or pivot, will impart an outward biasing force to resist closure and after closure. The outward biasing force, in one mode of the device, may, as noted, be provided by forming the members of polymeric material which will bend in an elastic manner such that they both will impart outward bias to return to a first position once pressure ceases.

In another mode, the force may be provided by a living hinge or an engagement formed of polymeric material connecting the first member to the second member in the pivoting engagement therebetween. The body, formed of the engaged first and second members and/or the hinge or pivoting connection, can be injection molded to form a unitary structure, such that, in the first or default position, the body assumes a substantially “V” or “U” shape with the engaged first and second members. The user, employing fingers gripping the device, will initially use force to overcome the outward bias urging the first and second members apart to the first position, and thereby collapse the holder wherein a portion of the first member contacts against the second and/or the first mount contacts the third mount and the second mount contacts the fourth mount.

With the holder body collapsed to this second position, both the first strand and the second strand of floss may be slid to an insertion between two adjacent teeth. The positioning of the second strand an elevation from the a common point such as a top surface of the first member, in an elevation which is slightly below the elevation of the first strand above the common point on the first member, allows the first and second strand to substantially align in parallel when the floss holder body is collapsed with the first strand running immediately adjacent and above the second strand.

While the flossing device herein will function and provide significant utility without this alignment, it has been found in experimentation that the aligned strands, at slightly different elevations when the first member is forced to contact against the second member, renders the device easier to insert in the gaps between adjacent teeth.

Once so inserted, the user may release the compressive force urging the first member toward the second member. This release of force will allow the outward biasing force generated by the inward flexed polymeric material or a living hinge, or in some cases, as spring hinges to urge the first member in a direction away from the second member back to the first position.

This outward biasing force on release is especially preferred in that where the two floss strands have been inserted between two teeth, the outward biasing force is then imparted to the first floss strand in a contact against a first tooth adjacent the gap and to the second strand against the second tooth on the opposite side of the gap therebetween.

When the flossing of the two teeth adjacent one gap therebetween is complete, the user may re-compress the first member against the second member to the second position again and insert the first strand aligned with the second strand into a different gap between different teeth. This process is repeated until all teeth have been flossed.

An additional preferred optional configuration of the body of the flossing device is the positioning of a first curved portion of the polymeric first member opposite a second curved portion of the polymeric second member. The two curved portions form a space therebetween when the user imparts force to overcome the outward bias and move the first member to a contact with the second member. If additional force is required to align the two strands of floss at different elevations, thereafter the user can exert additional opposing force against the first and second curved portions to cause the polymeric material forming them, to straighten out.

This allows the user to impart an increased compression force generated for straightening both the first and second curved portions and to move the first member against the second member, and thereby form an enhanced biased contact of the inside surface of the first member against the inner surface of the second member. This contact can aid in forming the aligned positioning of the first floss strand running parallel and adjacent to the second floss strand. During insertion into a gap between two teeth, such an alignment is preferred to render the device easier to push the first and second floss strands into the gap, especially where adjacent teeth touch.

With respect to the disclosed flossing device and method herein, before explaining at least one preferred embodiment, it is to be understood that the disclosed flossing invention is not limited in its application to the details of operation nor the arrangement of the components or the steps set forth in the following description or illustrations in the drawings. The various structural configurations and implementation of the flossing device herein are capable of other embodiments and of being practiced and carried out in various ways which will be obvious to those skilled in the art once they review this disclosure. Also, it is to be understood that the phraseology and terminology employed herein are for the purpose of description and should not be regarded as limiting.

Therefore, those skilled in the art will appreciate that the conception upon which this disclosure is based may readily be utilized as a basis for designing of other methods, device configurations and systems for carrying out the several purposes of the disclosed flossing device and system herein. Therefore, the objects and claims herein should be regarded as including such equivalent construction, components, steps, and methodology insofar as they do not depart from the spirit and scope of the present invention.

It is an object of this invention to provide a flossing device having pre-stretch or taut floss positioned in two locations on a body of a flossing holder which is easily gripped by the user during use.

It is another object of this invention to provide such a flossing holder wherein two taut lengths of floss are operatively positioned to engage against the surfaces of two adjacent teeth during flossing.

It is a further object of this invention to provide such a flossing holder with two strands thereon, wherein both strands are biased in opposite directions and against respective teeth surfaces on opposing sides of a gap therebetween, once the user releases compacting pressure, to thereby clean the opposing teeth surfaces of adjoining teeth.

These, together with other objects and advantages which become subsequently apparent, reside in the details of the construction and configurations of the flossing device herein as more fully hereinafter described and claimed, reference being had to the accompanying drawings forming a part thereof, wherein like numerals refer to like parts throughout.

Also, further objectives of this flossing invention will be ascertained by those skilled in the art as brought out in the following part of the specification wherein the detailed description is for the purpose of fully disclosing the invention without placing limitations thereon.

As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements. Finally, by the term “substantially” with regard to size or volume is meant plus or minus five percent, unless respectively otherwise defined, and by the term “substantially” with regard to alignment and positioning is meant plus or minus five degrees.

### BRIEF DESCRIPTION OF DRAWING FIGURES

The accompanying drawings, which are incorporated herein and form a part of the specification, illustrate some, but not the only or exclusive examples of embodiments and/or features of the disclosed flossing device. It is intended that the embodiments and figures disclosed herein are to be considered illustrative of the invention herein, rather than limiting in any fashion.

In the drawings:

FIG. 1 depicts a perspective view of the body of the flossing holder showing it in a first or expanded configuration wherein a first and second member forming the body are in a default position biased apart and extending from a flexing or a pivoting engagement, without the floss operatively engaged.

FIG. 2 shows a perspective view of the body of the flossing holder of FIG. 1 in the first or expanded configuration, wherein the first and second members are positioned apart with a gap therebetween in the their engagement at first ends, and the two strands of floss are operatively engaged, preferably in parallel positioning and at differing elevations.

FIG. 3 shows an overhead view of the device in the first position with the two polymeric members of the polymeric body or in some cases a metal body, in the first position having a gap therebetween as in FIG. 2, and also showing enlarged depictions of the floss.

FIG. 4 shows an overhead view of the device, as in FIG. 3, wherein the first member and second member holding respective individual strands of floss have been moved to a second position by pressure exerted by the user wherein the side surface of the first member contacts an opposing side surface of the second member.

FIG. 5 shows the flossing device of FIGS. 2-4 wherein compression between the fingers of a user has forced the first and second members to the second position with an increased biased contact of side surfaces against each other thereby positioning the two strands of floss in an alignment and ready for insertion in a gap between two adjacent teeth.

FIG. 6 depicts a side view of the device, as in FIG. 5, showing the preferred positioning of the two portions of floss in a parallel alignment with one floss portion located adjacent to and at an elevation below the other floss portion.

FIG. 7 shows the device wherein the first and second members are forced into contact and the aligned floss sections are inserted into a gap in between adjoining teeth.

FIG. 8 shows the flossing device of FIG. 7 moved to a third flossing position wherein the user has removed the biasing force to compress the first member toward the second, whereby the outward bias will move toward the first and second members toward their original positions of FIG. 2 and impart opposing biasing forces to the respective floss strands engaged thereto and against the respective surfaces of adjacent teeth.

### DETAILED DESCRIPTION OF THE PREFERRED EMBODIMENTS OF THE INVENTION

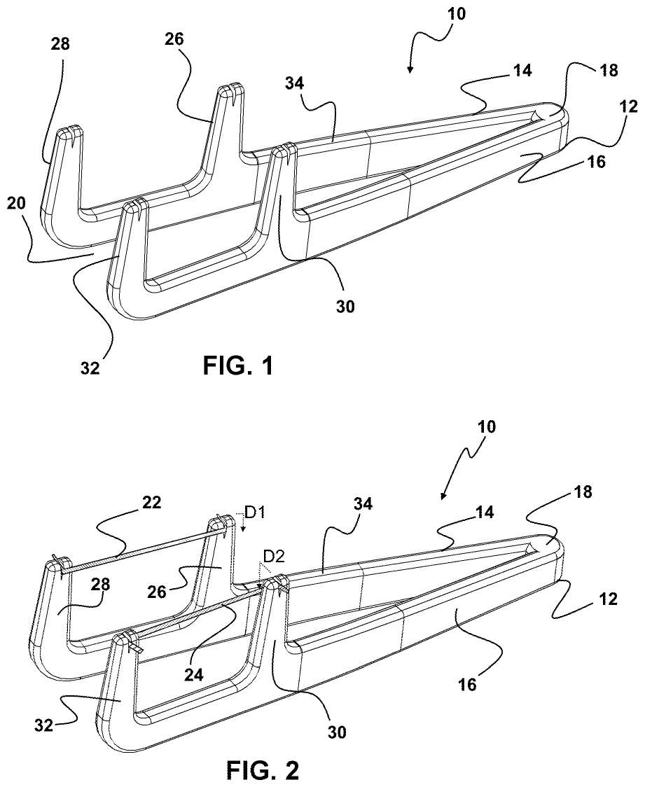

Referring now to the flossing device 10 herein shown in simple format by the depictions of FIGS. 1-8, there is seen in FIGS. 1-2 perspective views of the body 12 of the flossing holder device 10. The body 12 of the device 10 has a first member 14 positioned opposite a second member 16. The first end of the first member 14 and the first end of the second member 16 are in a first or expanded positioning wherein a gap 20 is formed between the first member 14 and the second member 16 and the body 12 assumes a substantially “V” or “U” shape in this first or default position. The body 12 can be molded from polymeric material such as nylon or polyethylene or polypropylene or similar polymeric materials to form it in this “V” or “U” shape where the first member 14 and second member 16 will flex and move toward each other, as in FIG. 4-6, when pressure is applied by the fingers of a user. As noted above, the first member 14 and second member 16 may also be formed of a flexible metal and will yield the outward bias when compressed to the second position from the first position.

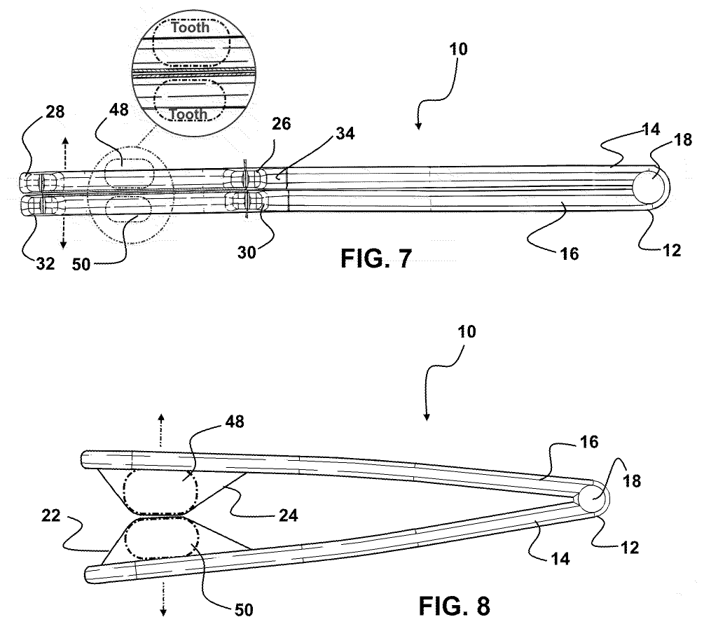

From this first or default position of the body 12, the user can overcome an outward bias of the first member 14 and second member 16 to stay straight and in position, by compressing the first member 14 against the second member 16, as in FIGS. 4-5, wherein the first inner edge 36 of the first member contacts the second inner edge 38 of the second member 16. As noted, in this second position of the device 10 the first strand 22 and second strand 24 are substantially aligned or positioned immediately adjacent each other rendering them easily slid into the gap between two teeth such as in FIG. 7.

Thereafter, releasing the user imparted force to the first and second members 14 and 16 will cause them to bias away from each other and move apart toward the first or default position of FIGS. 1-2. The polymeric material or, as noted, a flexible metal material forming the body 12 and two members will continuously impart this outward bias when the two members are compressed against each other. Such is depicted in FIG. 8, wherein the outward bias imparted from both polymeric members or metal members returning to their original position is respectively communicated to the first strand 22 of dental floss contacting a first tooth and the second strand 24 of dental floss biasly contacting against a second tooth.

The first strand 22 of dental floss is operatively engaged to a first strand mount located at a second end of the first member 14. The second strand 24 of dental floss is operatively engaged to a second strand mount located at a second end of the second member 16. By operatively engaged is meant that the respective dental floss strand is held taut at both ends with a space between the two ends such that both strands of floss with the body moved to the second position can be inserted into a gap between teeth and thereafter be slid upon the teeth in a flossing action.

As shown, the first strand 22 of dental floss is engaged at opposing ends to a first strand mount formed by the first mount 26 and a second mount 28, both of which extend from the first member 14. So engaged, the first strand 22 of dental floss is held taut across the first gap between the first mount 26 and second mount 28.

The second strand 24 of dental floss is taut and engaged at opposing ends to the second strand mount which is formed by a third mount 30 and fourth mount 32 both of which extend from the second member 16. The second strand 24 of dental floss is held taut by this engagement and extends across a second gap in between the third mount 30 and fourth mount 32.

Particularly preferred is the positioning of the first strand 22 a first distance D1 from a common position, such as edge 34 from which the first mount 26 extends, and the second strand 24 running substantially parallel and adjacent to the first strand 22 at a distance D2 from the edge 34, which is slightly less than the distance D1. This causes the first strand 22 and second strand 24 to run substantially parallel and to substantially align in the same vertical plane when the first member 14 is compressed against the second member 16, as in FIG. 5. Without this parallel and adjacent positioning, the first strand 22 and second strand 24 may align and contact each other in the horizontal plane forming a wider pair of strands.

With this parallel and adjacent positioning in the same vertical plane at slightly different elevations of D1 and D2, the two strands of floss 22 and 24 are positioned adjacent each other when the body is moved to the second position of FIG. 4 or 5, which makes it a bit easier to slide both aligned and adjacently positioned strands 22 and 24, through a gap in the teeth of the user during use and is thus preferred.

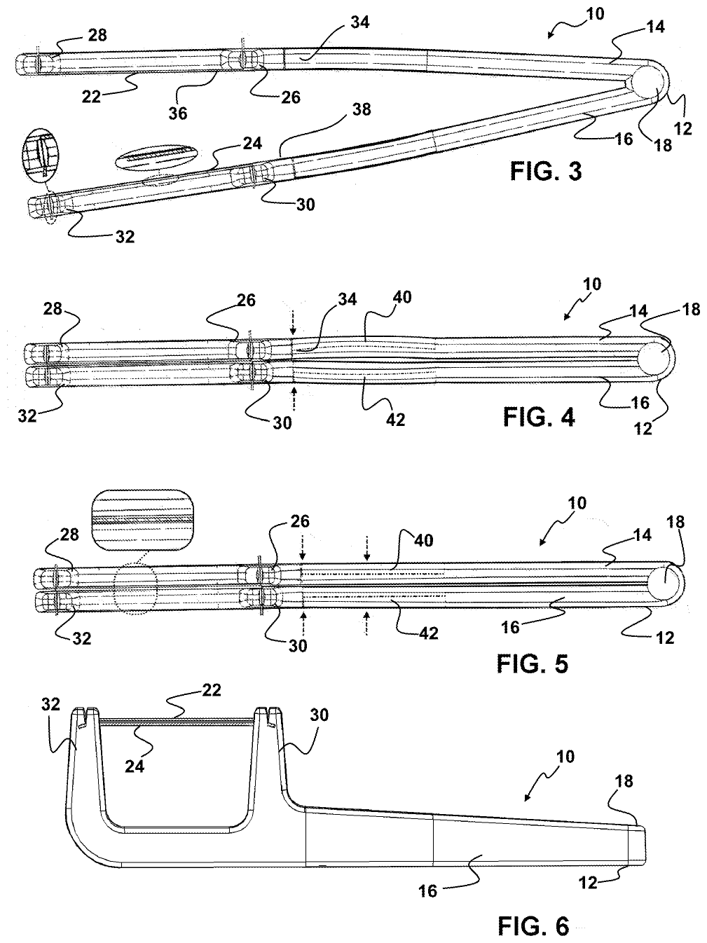

In FIG. 3 is shown an overhead view of the device 10 as in FIG. 2, and also shows enlarged depictions of the second strand 24 of floss. The first strand of floss 22 engages with the first strand mount formed by the first mount 26 and second mount 28 in a manner that it extends and aligns substantially with the first inner edge 36 of the first member 14 which extends up both the first and second mounts. In the same fashion, the second strand 24 extends between engagements with the third mount 30 and fourth mount 32 substantially aligned with and in contact with the second inner edge 38 of the second member 16.

When the user compresses the first member 14, such that the first inner edge 36 thereof contacts against the second inner edge 38 of the second member 16, it places the first strand 22 of dental floss substantially aligned with the second strand 24 of dental floss, with the second strand 24 being adjacent to and slightly lower than the first strand 22 where they are at differing elevations. Both are thus aligned along an imaginary vertical plane running between the first inner edge 36 and second inner edge 38 and running adjacent and parallel to each other, as in FIG. 5, with one strand above and adjacent the other.

In FIGS. 4-5 is depicted overhead views of the device 10, as in FIG. 3, wherein the first member 14 and second member 16, holding respective individual strands of floss, have been moved to a second position by the user, overcoming the outward bias imparted by the first member 14 in the engagement at the first end with the second member 16, which continuously urges the members toward the first or default position of FIG. 1-2. As shown, the first strand 22 is positioned slightly higher in elevation than the second strand 24 but parallel and aligned with the second strand 24, as described above.

In FIG. 4, in another mode of the device 10, a first curved portion 40 of the first member 14 is located in a central area thereof in between the connection 18 and the first mount 26. A second curved portion 42, substantially aligned with the first curved portion 40, is positioned between the connection 18 and the third mount 30. This second curved portion 42 curves away from and in an opposite direction from the first curved portion 40.

This connection 18, currently, is a portion of polymeric material from which the first member 14 and second member 16 are formed since both the first member 14 and second member 16 will bend once the user imparts force upon them to move toward each other. Also, the first member 14 and second member 16 will inherently return to the first position for the body 12 as in FIGS. 1-2 once the pressure is released and the polymeric material which is elastic in nature in that it will move toward its original position.

However, this connection 18 can also be a living hinge formed of the polymeric material, or in models of the device 10, which may be more expensive, an actual pivot or hinged engagement which has a spring or other biasing component urging the connected first member 14 and second member 16 back to the first position having the gap 20 therebetween.

In this configuration, when the first member 14 is moved to contact the second member 16, as in FIG. 4, a void 44 is formed between the first curved portion 40 and the second curved portion 42. While the device will operate well without the curved portions and the void 44, such can be included to enhance operation of the device 10. When included, it gives the user the ability to impart more pressure to the first member 14 against the second member 16 than they can without the curved portions, which can be of help to better align the first strand 22 with the second strand 24 in the same vertical plane, during insertion of the two strands 22 and 24 between two teeth. The void 44 allows the user to impart extra pressure to bend the both the first member 14 and the first curved portion 40 and second member 16 and the second curved portion 42 to straighten them and reduce the void 44 size, which imparts significantly more biasing force to hold the first inner edge 36 of the first member 14 in contact against the second inner edge 38 of the second member 14 to form the aligned and adjacent strands 22 and 24.

Shown in FIG. 6 is a side view of the device 10, as in FIG. 5, showing the preferred positioning of the first strand 22 of floss with the second strand 24 of floss. As shown, the two strands run substantially parallel and adjacent to each other which, as noted above, is a positioning provided by locating the first strand 22 the elevation distance D1 from a common point such as the top edge 34 which is slightly larger than the elevation distance D2.

In FIG. 7 is shown the device 10 being inserted into the tooth gap 46 located between a first tooth 48 and a second tooth 50. Such is done when the user has moved the device 10 to the compressed configuration of FIGS. 4-5 by imparting force with their fingers to bend or move the first member 14 to contact against the second member 16, with the first strand 22 of floss aligned with and parallel to the adjacent second strand 24 of floss.

Once the device 10 is moved to an inserted position with the two strands 22 and 24 within the tooth gap 46, such as in FIG. 7, when the user releases the pressure used to overcome the imparted outward bias provided by the polymeric material returning to the first position, as in FIG. 2, the first member 14 and second member 16 will move toward the default configuration of FIGS. 1-2. However, since the gap 20 is wider than the tooth gap 46, the outward bias causes the first strand 22 to biasly contact against the first tooth 48 and second strand 24 to biasly contact against the second tooth 50 whereupon the user need only slide the two strands on the teeth they respectively contact in a back and forth flossing motion.

Using the device 10, not only are two teeth being flossed at once instead of one, as would be done manually, but both strands are continuously biased in contact against the respective teeth, thereby yielding easier and much speedier flossing versus trying to maintain the user's fingers and a single strand in a flossing position. It is the outward bias imparted to the first member 14 and second member 16 which provides the biased contact of floss with teeth once the user releases the pressure imparted to move the device to the second position.

While all of the fundamental characteristics and features of the flossing device and system herein have been shown and described herein, with reference to particular embodiments thereof, a latitude of modification, various changes and substitutions are intended in the foregoing disclosure and it will be apparent that in some instances, some features of the flossing invention may be employed without a corresponding use of other features thereof, without departing from the scope of the invention as set forth. It should also be understood that various substitutions, modifications, and variations may be made by those skilled in the art upon their review of this specification without departing from the spirit or scope of the invention. Consequently, all such modifications and variations and substitutions are included within the scope of the invention as defined by the following claims.

What is claimed is:

1. A flossing apparatus, comprising:
a body having a first member and a second member;
a connection engaging a first end of said first member with a first end of said second member;
said body having a first position having a gap between said first member and said second member;
said body moveable to a second position wherein said first member contacts said second member by a compression of said first member and said second member toward each other;
a first floss strand operatively positioned on a first floss mount at a second end of said first member;
a second floss strand operatively positioned on a second floss mount at a second end of said second member; and
said first floss strand and said second floss strand positionable into a gap between a first tooth and an adjoining second tooth of a user with said body in said second position; and
said body being urged toward said first position by an outward bias of said first member and said second member upon cessation of said compression, said outward bias imparting a biased contact of said first floss strand against said first tooth and said second floss strand against said second tooth wherein said user can floss said first and second tooth by flossing movement of said body.

2. The flossing apparatus of claim 1, additionally comprising:
said first floss strand extending in a contact of opposing ends thereof with an interior surface of said first member;
said second floss strand extending in a contact of opposing ends thereof with an interior surface of said second member;
said first floss strand at a first elevation above an upper edge of said first member;
said second floss strand at a second elevation above said upper edge of said second member; and
said second elevation being lower than said first elevation thereby positioning said second floss strand adjacent to said first floss strand, wherein said first floss stand and said second floss strand are substantially aligned with said body in said second position.

3. The flossing apparatus of claim 1, additionally comprising:
said first floss mount at said second end of said first member having a first mount extending from said first member in a substantial alignment with a second mount extending from said first member;
said first floss strand extending across a first strand gap positioned between said first floss mount and said second floss mount;
said second floss mount at said second end of said second member having a third mount extending from said second member in a substantial alignment with a fourth mount extending from said second member; and
said second floss strand extending across a second strand gap positioned between said third floss mount and said fourth floss mount.

4. The flossing apparatus of claim 2, additionally comprising:
said first floss mount at said second end of said first member having a first mount extending from said first member in a substantial alignment with a second mount extending from said first member;
said first floss strand extending across a first strand gap positioned between said first floss mount and said second floss mount;
said second floss mount at said second end of said second member having a third mount extending from said second member in a substantial alignment with a fourth mount extending from said second member; and
said second floss strand extending across a second strand gap positioned between said third floss mount and said fourth floss mount.

5. The flossing apparatus of claim 1, additionally comprising:
said first member and said second member being formed of polymeric material which generates said outward bias upon said compression of said first member toward said second member.

6. The flossing apparatus of claim 2, additionally comprising:
said first member and said second member being formed of polymeric material which generates said outward bias upon said compression of said first member toward said second member.

7. The flossing apparatus of claim 3, additionally comprising:
said first member and said second member being formed of polymeric material which generates said outward bias upon said compression of said first member toward said second member.

8. The flossing apparatus of claim 4, additionally comprising:
said first member and said second member being formed of polymeric material which generates said outward bias upon said compression of said first member toward said second member.

9. The flossing apparatus of claim 1, additionally comprising:
said connection of said first member to said second member being a pivoting connection which generates said outward bias upon said compression of said first member toward said second member.

10. The flossing apparatus of claim 2, additionally comprising:
said connection of said first member to said second member being a pivoting connection which generates said outward bias upon said compression of said first member toward said second member.

11. The flossing apparatus of claim 3, additionally comprising:
said connection of said first member to said second member being a pivoting connection which generates said outward bias upon said compression of said first member toward said second member.

12. The flossing apparatus of claim 4, additionally comprising:
said connection of said first member to said second member being a pivoting connection which generates said outward bias upon said compression of said first member toward said second member.

13. The flossing apparatus of claim 1, additionally comprising:
said first member and said second member being formed of flexible metal material which generates said outward bias upon said compression of said first member toward said second member to move the body to said second position.
